(19) United States
(12) Patent Application Publication
(10) Pub. No.: US 2008/0036578 A1
(43) Pub. Date: Feb. 14, 2008

(54) CONTROL APPARATUS AND METHOD AND RELATED PROGRAM

(75) Inventor: Hiroki Toyama, Kasugai-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/739,321

(22) Filed: Apr. 24, 2007

(30) Foreign Application Priority Data
Apr. 27, 2006 (JP) 2006-122971

(51) Int. Cl. B60R 25/10

(52) U.S. Cl. 340/426.1; 701/49

(57) ABSTRACT

If a manipulation on the open switch of an outdoor manipulation section which is a manipulation section for open or close the associated door from outside a train is detected in a state that an operation of opening a door of the train is prohibited, a door control section for controlling the doors as the opening/closing members of the train outputs, to a main control section, a control signal indicating occurrence of an abnormal manipulation. For example, the invention can be applied to control systems of trains and automobiles.

### CONTROL APPARATUS AND METHOD AND RELATED PROGRAM

This application claims priority from Japanese patent application 122971/2006, filed on Apr. 27, 2006. The entire contents of the aforementioned application is incorporated herein by reference.

### BACKGROUND OF THE INVENTION

1. Field of the Invention

The present invention relates to a control apparatus and method and a related program. In particular, the invention relates to a control apparatus and method and a related program which make it possible to quickly detect an abnormal manipulation performed in an automobile, a train, or the like.

2. Description of the Related Art

In apparatus involving human manipulations, a control for prohibiting a manipulation that need not or should not be performed ordinarily in a prescribed state may be performed for safety of a person who makes a manipulation or protection of the apparatus.

For example, in the automobile control, a control for prohibiting door unlocking during a run may be performed to prevent a door from opening during the run (refer to JP-A-2003-269028, for example).

Also in the train door control, in trains which are not of such a type that the conductor opens or closes all the doors of the train but of such a type that a passenger himself or herself opens or closes the pair of doors through which he or she is going to get on or off by manipulating the associated one of open/close switches that are provided near the respective pairs of doors, a control is performed which disables the doors from being opened or closed by manipulating an open/close switch during a run.

In the automobile control and the train control, for safety of persons, quickly detecting an abnormal manipulation among various manipulations performed by persons is now required more severely.

### SUMMARY OF THE INVENTION

The present invention has been made in view of the above circumstances, and an object of the invention is therefore to make it possible to quickly detect an abnormal operation performed in an automobile, a train, or the like.

According to one aspect of the invention, a control apparatus of a mobile body which runs while carrying persons comprises detecting means for detecting a manipulation that is performed on a manipulation member to open or close an opening/closing member from outside the mobile body; and output means for outputting a control signal indicating occurrence of an abnormal manipulation if a manipulation that is performed on a manipulation member to open an opening/closing member from outside the mobile body is detected in a state that an open operation of the opening/closing member is prohibited.

In the control apparatus according to the one aspect of the invention, a control signal indicating occurrence of an abnormal manipulation is output if a manipulation that is performed on a manipulation member to open an opening/closing member from outside the mobile body is detected in a state that an open operation of the opening/closing member is prohibited. This makes it possible to quickly detect an abnormal manipulation performed in an automobile, a train, or the like.

For example, the detecting means is a manipulation signal detecting section which is a logic circuit, a CPU (central processing unit), or the like, and the output means is a judgment section which is a logic circuit, a CPU, or the like.

The state that an open operation of the opening/closing member is prohibited may be a state that the mobile body is running.

The output means may be such as to output, as the control signal, a control signal for causing an operation of notifying a driver of the mobile body or a control signal for causing an operation of stopping the mobile body which is running.

The control apparatus may be a control apparatus for the opening/closing member.

According to another aspect of the invention, a control method of a mobile body which runs while carrying persons comprises the steps of detecting a manipulation that is performed on a manipulation member to open or close an opening/closing member from outside the mobile body; and outputting a control signal indicating occurrence of an abnormal manipulation if a manipulation that is performed on a manipulation member to open an opening/closing member from outside the mobile body is detected in a state that an open operation of the opening/closing member is prohibited.

According to a further aspect of the invention, in a program for causing a computer to execute a control process for controlling a mobile body which runs while carrying persons, the control process comprises the steps of detecting a manipulation that is performed on a manipulation member to open or close an opening/closing member from outside the mobile body; and outputting a control signal indicating occurrence of an abnormal manipulation if a manipulation that is performed on a manipulation member to open an opening/closing member from outside the mobile body is detected in a state that an open operation of the opening/closing member is prohibited.

In the control method and the program according to the respective aspects of the invention, a control signal indicating occurrence of an abnormal manipulation is output if a manipulation that is performed on a manipulation member to open an opening/closing member from outside the mobile body is detected in a state that an open operation of the opening/closing member is prohibited. This makes it possible to quickly detect an abnormal manipulation performed in an automobile, a train, or the like.

According to the aspects of the invention, an abnormal manipulation performed in an automobile, train or the like can quickly be detected.

### BRIEF DESCRIPTION OF THE DRAWINGS

FIG. 1 shows an exemplary configuration of a control system according to an embodiment of the present invention;

FIG. 2 is a block diagram showing an exemplary, detailed configuration of a door control section shown in FIG. 1;

FIG. 3 is a flowchart of a judgment process;

FIG. 4 is a flowchart of an abnormal manipulation accommodating process;

FIG. 5 shows an exemplary configuration of a control system according to another embodiment of the invention;

FIG. 6 is a block diagram showing an exemplary, detailed configuration of a door control section shown in FIG. 5;

FIG. 7 is a flowchart of another judgment process;

FIG. 8 is a flowchart of an abnormal manipulation judgment process; and

FIG. 9 is a block diagram of a computer according to a further embodiment of the invention.

### DESCRIPTION OF THE PREFERRED EMBODIMENTS

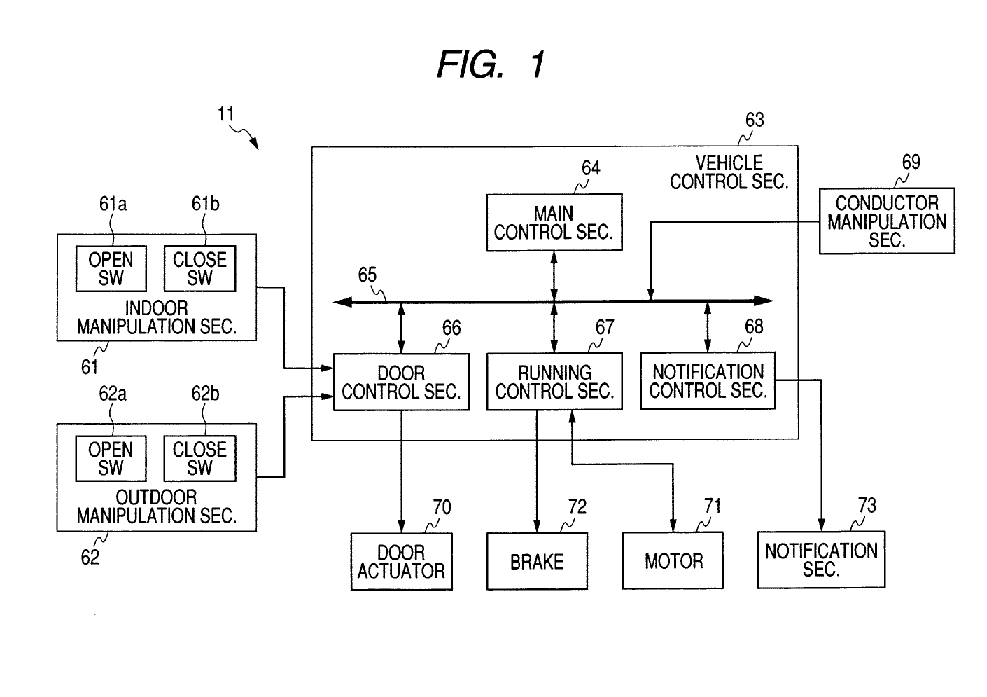

FIG. 1 is a block diagram showing an exemplary configuration of a control system according to a first embodiment of the present invention.

A train control system 11 of FIG. 1 is a control system which is provided in a train and is composed of indoor manipulation sections 61, outdoor manipulation sections 62, a vehicle control section 63, a conductor manipulation section 69, a door actuator 70, a motor 71, a brake 72, and a notification section 73. The vehicle control section 63 is composed of a main control section 64, a bus 65, a door control section 66, a running control section 67, and a notification control section 68. It is assumed that the train of this embodiment is not of such a type that the conductor opens or closes all the doors of the train but of such a type that a passenger himself or herself opens or closes the pair of doors through which he or she is going to get on or off by manipulating the associated one of open/close switches that are provided near the respective pairs of doors.

Each indoor manipulation section 61 is disposed inside the vehicle in the associated door unit or disposed inside the vehicle near the associated pair of doors and is equipped with an open SW (switch) 61a for opening the pair of doors and a close SW 61b for closing the pair of doors. For example, the open SW 61a is manipulated when a passenger existing inside the train opens the pair of doors to get off the train. For example, the close SW 61b is manipulated when a passenger who has got on closes the pair of doors. When the open SW 61a or close SW 61b is manipulated by a passenger, the indoor manipulation section 61 supplies a manipulation signal of the manipulated open SW 61a or close SW 61b to the door control section 66.

Each outdoor manipulation section 62 is disposed outside the vehicle in the associated door unit or disposed outside the vehicle near the associated pair of doors and is equipped with an open SW 62a for opening the pair of doors and a close SW 62b for closing the pair of doors. For example, the outside open SW 62a is manipulated when a passenger existing outside the train opens the pair of doors to get on the train. For example, the outside close SW 62b is manipulated when a passenger who has got off closes the pair of doors. When the outside open SW 62a or close SW 62b is manipulated by a passenger, the outdoor manipulation section 62 supplies a manipulation signal of the manipulated open SW 62a or close SW 62b to the door control section 66.

In each indoor manipulation section 61, the inside open SW 61a and close SW 61b need not be two switches that are separated from each other physically. For example, each indoor manipulation section 61 may be equipped with only a single switch (manipulation member) on which an open manipulation and a close manipulation are performed alternately or with which an open manipulation and a close manipulation are discriminated from each other by, for example, changing the manner of manipulation. The same applies to each outdoor manipulation section 62.

The vehicle control section 63 controls the entire train as the main control section 64, the door control section 66, the running control section 67, and the notification control section 68 exchange control signals via the bus 65. Although in this embodiment the vehicle control section 63 is composed of only the main control section 64, the door control section 66, the running control section 67, and the notification control section 68, it may naturally include other control sections as the vehicle control section 63.

The main control section 64 supplies one of various control signals to a control section on which a control has become necessary in response to a control signal supplied from the door control section 66, the running control section 67, or the notification control section 68.

For example, when supplied by the door control section 66 with a control signal indicating occurrence of an abnormal manipulation, the main control section 64 supplies a notification instruction signal to the notification control section 68.

In response to a manipulation signal of an open SW 61a, a close SW 61b, an open SW 62a, or a close SW 62b which is supplied from an indoor manipulation section 61 or an outdoor manipulation section 62, the door control section 66 supplies the door actuator 70 with an open operation instruction signal or a close operation instruction signal for the corresponding pair of doors as a pair of opening/closing members of the train. That is, when supplied with a manipulation signal of an inside open SW 61a or an outside open SW 62a, the door control section 66 supplies a door open operation instruction signal to the door actuator 70. When supplied with a manipulation signal of an inside close SW 61b or an outside close SW 62b, the door control section 66 supplies a door close operation instruction signal to the door actuator 70. In response to the door open or close operation instruction signal, the door actuator 70 performs an operation of opening or closing the pair of doors.

However, if a status signal indicating a state that a door opening operation is prohibited (hereinafter referred to as “prohibition state” where appropriate) is being supplied from the conductor manipulation section 69 via the bus 65, the door control section 66 does not supply a door open operation instruction signal to the door actuator 70 even if supplied with a manipulation signal of an inside open SW 61a or an outside open SW 62a.

The running control section 67 controls the motor 71 and the brake 72 according to a running instruction signal or a stop instruction signal which is supplied from the main control section 64. That is, the running control section 67 increases or decreases the rotation speed of the wheels by controlling the motor 71 and the brake 72. The running control section 67 can detect the rotation state of the wheels by receiving a rotation signal indicating the current rotation speed of the wheels from the motor 71.

The notification control section 68 controls the notification section 73. In this embodiment, the notification section 73 incorporates buzzers, for example. In response to a notification instruction signal which is supplied from the main control section 64, the notification control section 68 supplies the notification section 73 with a control signal for ringing the buzzers. The notification section 73 incorporates buzzers which are disposed in the driver's room and the conductor's room and rings the buzzers when supplied with a control signal.

The conductor manipulation section 69 has various manipulation devices and members to be manipulated by the conductor, such as a microphone, switches for vehicle inside illumination, and air-conditioner switches. The conductor manipulation section 69 has a door control manipulation member for setting a state that an open operation on the doors of the train is permitted (permission state) or a state that it is prohibited (prohibition state). If the conductor manipulates that manipulation member, the conductor manipulation section 69 outputs a status signal indicating a prohibition state or a permission state. The conductor sets the state in accordance with the running state of the train; that is, the conductor sets a permission state only when the train is stopped at a station.

Alternatively, the door open operation prohibition/permission control may be performed according to instructions from a service management system which performs service management of the train rather than according to manipulations by the conductor. In this case, the service management system supplies the vehicle control section 63 with a status signal indicating a permission state only when the train is stopped at a station.

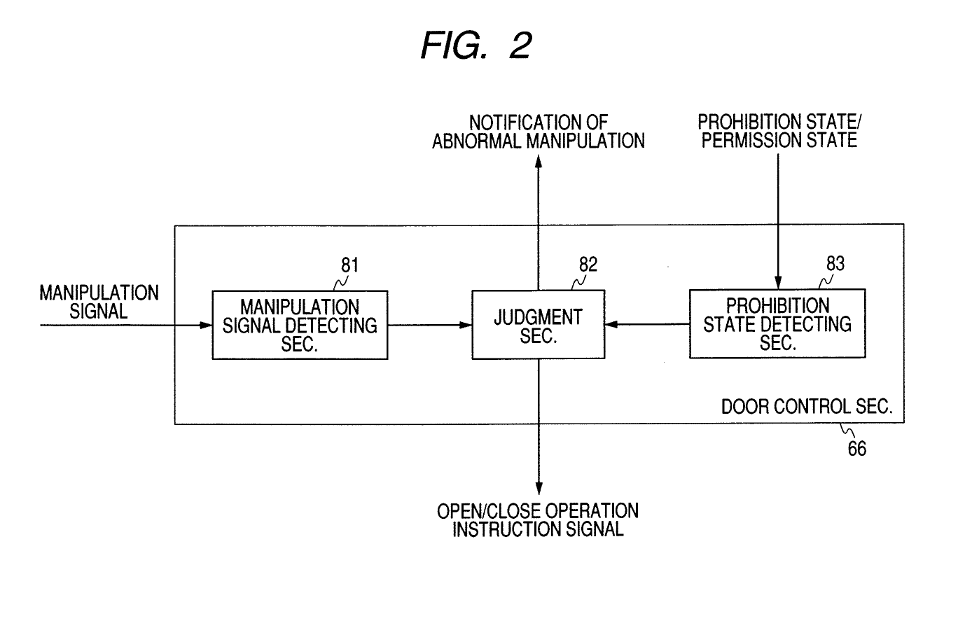

FIG. 2 is a block diagram showing an exemplary, detailed configuration of the door control section 66 shown in FIG. 1.

The door control section 66 is composed of a manipulation signal detecting section 81, a judgment section 82, and a prohibition state detecting section 83 each of which is a logic circuit (signal processing circuit), for example, which performs logical operations on a received signal.

The manipulation signal detecting section 81 detects that an open SW 61a, a close SW 61b, an open SW 62a, or a close SW 62b has been manipulated when receiving a manipulation signal of the open SW 61a, close SW 61b, open SW 62a, or close SW 62b which is supplied from an indoor manipulation section 61 or an outdoor manipulation section 62. The manipulation signal detecting section 81 supplies the received manipulation signal to the judgment section 82.

The judgment section 82 is supplied by the manipulation signal detecting section 81 with a manipulation signal of an open SW 61a, a close SW 61b, an open SW 62a, or a close SW 62b. The judgment section 82 judges, on the basis of a status signal supplied from the prohibition state detecting section 83, whether the manipulation on the open SW 61a, close SW 61b, open SW 62a, or close SW 62b that has been detected by the manipulation signal detecting section 81 is a normal one or an abnormal one, and performs a control suitable for the judgment result.

More specifically, if a manipulation on an inside open SW 61a or close SW 61b or an outside open SW 62a or close SW 62b is detected in a state that a status signal indicating a permission state is being supplied from the prohibition state detecting section 83, the judgment section 82 judges that the detected manipulation is a normal one and supplies the door actuator 70 with a door open operation instruction signal or a door close operation instruction signal corresponding to the manipulation signal of the open SW 61a, close SW 61b, open SW 62a, or close SW 62b.

On the other hand, if supplied by the manipulation signal detecting section 81 with a manipulation signal of the open SW 62a or the close SW 62b of an outdoor manipulation section 62 in a state that a status signal indicating a prohibition state is being supplied from the prohibition state detecting section 83, the judgment section 82 judges that the detected manipulation is an abnormal one and supplies a control signal indicating occurrence of an abnormal manipulation to the main control section 64 via the bus 65 (see FIG. 1) without supplying a door open operation signal or a door close operation signal to the door actuator 70.

If supplied by the manipulation signal detecting section 81 with a manipulation signal of the open SW 61a or the close SW 61b of an indoor manipulation section 61 in a state that a status signal indicating a prohibition state is being supplied from the prohibition state detecting section 83, the judgment section 82 judges that the detected manipulation is a prohibited one and does not supply a door open operation signal or a door close operation signal to the door actuator 70. This is because this event is merely such that a passenger in the train inadvertently touched or mischievously manipulated the open SW 61a or the close SW 61b of the indoor manipulation section 61 and hence it does not require an emergency measure unlike in a case of a door manipulation from outside the train during a run. The fact that an inside open SW 61a or close SW 61b was manipulated may be communicated to the conductor manipulation section 69 so as to be recognized by the conductor. In this case, the conductor can make an announcement (e.g., by an in-train broadcast) to request the passengers not to manipulate an inside open SW 61a or close SW 61b during a run.

The judgment section 82 may supply a door close operation signal corresponding to the manipulation signal to the door actuator 70 when supplied by the manipulation signal detecting section 81 with a manipulation signal of the close SW 61b of an indoor manipulation section 61 in a state that a status signal indicating a prohibition state is being supplied from the prohibition state detecting section 83. This is because this operation does not substantially change the door open/close state and causes no danger to the passengers.

The prohibition state detecting section 83 detects a door open/close permission/prohibition state by receiving, from the conductor manipulation section 69, a status signal indicating a prohibition state or a permission state. The prohibition state detecting section 83 supplies the received status signal to the judgment section 82.

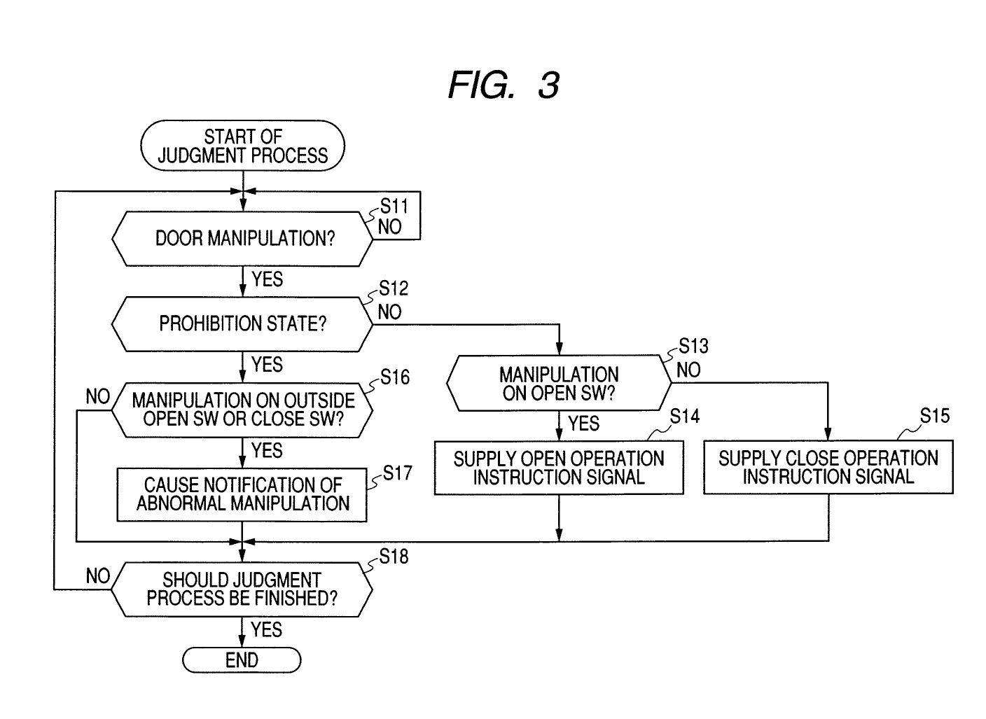

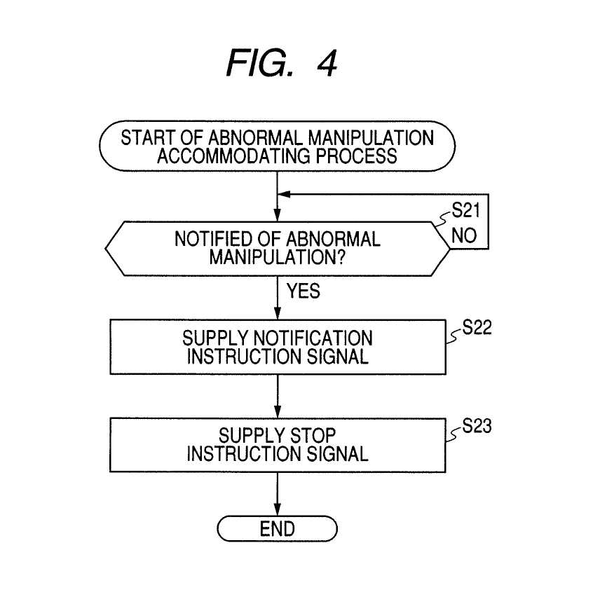

A judgment process of the judgment section 82 will be described below with reference to a flowchart of FIG. 3. For example, this process and a process of FIG. 4 (described later) are started upon a start of running of the train (i.e., a start of the engine) and executed in parallel.

First, at step S11, the judgment section 82 judges whether or not a door manipulation has been performed. This step is executed repeatedly until it is judged that a door manipulation has been performed.

If it is judged at step S11 that a door manipulation has been performed, that is, if a manipulation signal of an inside open SW 61a or close SW 61b or an outside open SW 62a or close SW 62b is supplied from the manipulation signal detecting section 81, the judgment section 82 judges at step S12 whether or not the door open/close permission/prohibition state is a prohibition state.

If it is judged at step S12 that the door open/close permission/prohibition state is not a prohibition state (i.e., it is a permission state), the judgment section 82 judges at step S13 whether the manipulation detected at step S11 is a manipulation on an indoor open SW 61a or an outdoor open SW 62a.

If it is judged at step S13 that the detected manipulation is a manipulation on an indoor open SW 61a or an outdoor open SW 62a, at step S14 the judgment section 82 supplies the door actuator 70 with a door open operation instruction signal corresponding to the manipulation signal of the open SW 61a or 62a. Then, the judgment section 82 moves to step S18.

On the other hand, if it is judged at step S13 that the detected manipulation is a manipulation on an indoor close SW 61b or an outdoor close SW 62b, at step S15 the judgment section 82 supplies the door actuator 70 with a door close operation instruction signal corresponding to the manipulation signal of the close SW 61b or 62b to move to the step S18.

On the other hand, if it is judged at step S12 that the door open/close permission/prohibition state is a prohibition state, the judgment section 82 judges at step S16 whether the manipulation detected at step S11 is a manipulation on an open SW 62a or a close SW 62b that is provided on the outside of the vehicle body.

If it is judged at step S16 that the detected manipulation is not a manipulation on an open SW 62a or a close SW 62b provided on the outside of the vehicle body, that is, if it is a manipulation on an inside open SW 61a or close SW 61b, the process moves to step S18 skipping step S17.

On the other hand, if it is judged at step S16 that the detected manipulation is a manipulation on an open SW 62a or a close SW 62b provided on the outside of the vehicle body, the judgment section 82 judges that the manipulation on the open SW 62a or close SW 61b of the outdoor manipulation section 62 which was detected at step S11 is an abnormal manipulation by a passenger and supplies (outputs) a control signal indicating occurrence of an abnormal manipulation to the main control section 64 via the bus 65. Then, the judgment section 82 moves to step S18.

At step S18, the judgment section 82 judges whether or not the judgment process should be finished. If judging that the judgment process should not be finished, the judgment section 82 returns to step S11, whereby the above-described steps S11-S18 will be executed again.

On the other hand, if judging that the judgment process should be finished, the judgment section 82 finishes the process. For example, the judgment section 82 judges that the process should be finished when the running of the train has been finished (i.e., when the driver has made a manipulation of finishing the running).

FIG. 4 is a flowchart of an abnormal manipulation accommodating process which is executed by the main control section 64 when it is supplied by the door control section 66 with a control signal indicating occurrence of an abnormal manipulation.

First, at step S21, the main control section 64 judges whether or not it has been notified of an abnormal manipulation, that is, whether or not a control signal indicating occurrence of an abnormal manipulation has been supplied from the judgment section 82 of the door control section 66. Step S21 is executed repeatedly until the main control section 64 judges that it has been notified of an abnormal manipulation.

If it is judged at step S21 that the main control section 64 judges that it has been notified of an abnormal manipulation, that is, if a control signal indicating occurrence of an abnormal manipulation has been supplied from the judgment section 82 of the door control section 66, at step S22 the main control section 64 supplies a notification instruction signal to the notification control section 68, whereupon the notification section 73 rings buzzers.

At step S23, the main control section 64 supplies a stop instruction signal to the running control section 67, whereupon the running control section 67 stops the train by controlling the motor 71 and the brake 72. Then, the process is finished.

Where the driver is supposed to make a train emergency stop manipulation upon recognizing an abnormal manipulation through notification by the notification section 73, step S23 can be omitted. However, stopping the train in response to a control signal supplied from the main control section 64 in the above-described manner is a quicker measure against an abnormal manipulation by a passenger.

As described above, a status signal indicating a prohibition state which prohibits a door open operation is supplied from the conductor manipulation section 69 to the door control section 66 except when the train is stopped at a station. If a manipulation on the open SW 62a of an outdoor manipulation section 62 is detected when the train is in a prohibition state, the judgment section 82 judges that the manipulation is an abnormal one and communicates a control signal indicating occurrence of an abnormal manipulation to the main control section 64. In this manner, an abnormal manipulation can be detected quickly.

When receiving a control signal indicating occurrence of an abnormal manipulation, the main control section 64 causes the notification section 73 to ring the buzzers, which allows the driver or the conductor to recognize the occurrence of the abnormal manipulation immediately. When receiving a control signal indicating occurrence of an abnormal manipulation, the main control section 64 outputs a stop instruction signal for causing the train to make an emergency stop. In this manner, a measure for securing safety of the passengers can be taken quickly.

Although in the above embodiment the notification section 73 incorporates buzzers, the notification section 73 may incorporate other devices such as speakers. In this case, when supplied by the main control section 64 with a notification instruction signal, the notification section 68 outputs to the notification section 73 a voice message such as “The door manipulation switch (outside open SW 62a) of the [ ]th car has been manipulated!” This allows the driver to instantaneously recognize not only the occurrence of the abnormality but also its content. As a further alternative, the notification section 73 may incorporate both of buzzers and speakers and cause both of ringing of the buzzers and output of a voice message. Furthermore, the content of an abnormality may be displayed on a display device disposed in front of the driver's seat, such as an LED (light-emitting diode) indicator or an LCD (liquid crystal display).

Next, a control system according to a second embodiment of the invention will be described.

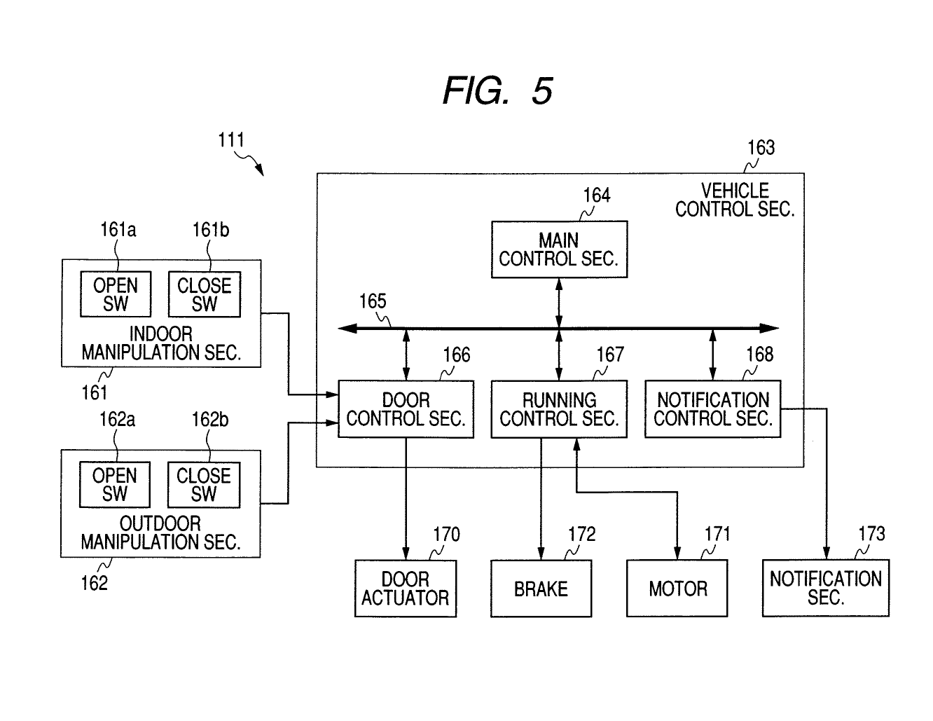

FIG. 5 shows an exemplary configuration of an automobile control system 111 in which the invention is applied to a control system of an automobile.

The automobile control system 111 is composed of indoor manipulation sections 161, outdoor manipulation sections 162, a vehicle control section 163, a door actuator 170, a motor 171, a brake 172, and a notification section 173. The vehicle control section 163 is composed of a main control section 164, a bus 165, a door control section 166, a running control section 167, and a notification control section 168.

The automobile control system 111 of FIG. 5 is different from the train control system 11 of FIG. 1 in that the former is not equipped with the conductor manipulation section 69 because of absence of a conductor. The other sections, that is, the indoor manipulation sections 161, outdoor manipulation sections 162, vehicle control section 163, main control section 164, bus 165, door control section 166, running control section 167, notification control section 168, door actuator 170, motor 171, brake 172, and notification section 173, of the former are approximately the same in configuration as the corresponding sections of the latter.

The indoor manipulation sections 161, outdoor manipulation sections 162, vehicle control section 163, main control section 164, bus 165, door control section 166, running control section 167, notification control section 168, door actuator 170, motor 171, brake 172, and notification section 173 shown in FIG. 5 perform approximately the same processing as the indoor manipulation sections 61, outdoor manipulation sections 62, vehicle control section 63, main control section 64, bus 65, door control section 66, running control section 67, notification control section 68, door actuator 70, motor 71, brake 72, and notification section 73 shown in FIG. 1.

However, the automobile control system 111 of FIG. 5 does not employ a status signal indicating a permission state or a prohibition state which is supplied from the conductor manipulation section 69 in the train control system 11 of FIG. 1. Instead, a status signal indicating a judgment result as to whether the vehicle is running or stopped which is produced by the running control section 167 on the basis of the rotation state of the wheels is supplied from the running control section 167 to the door control section 166 via the bus 165.

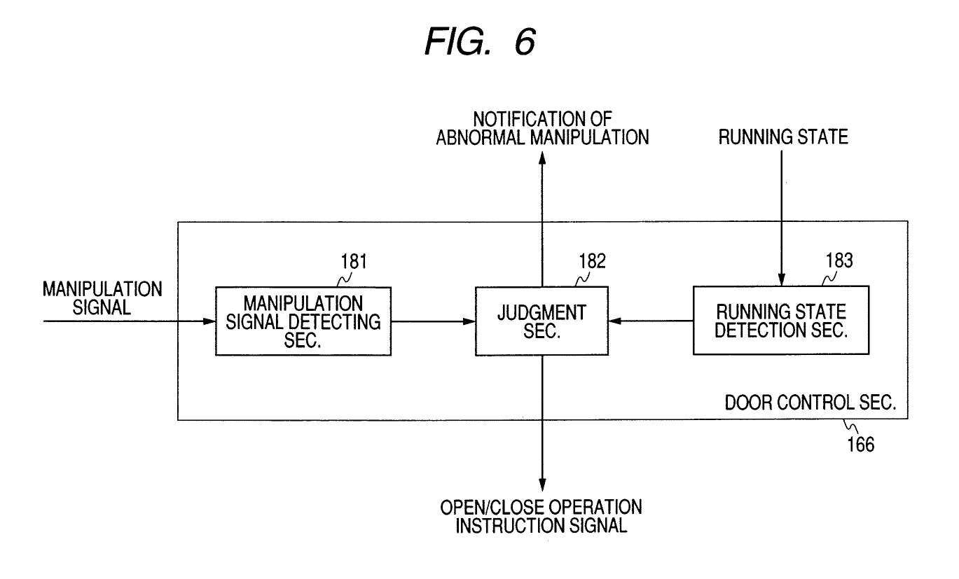

FIG. 6 is a block diagram showing an exemplary, detailed configuration of the door control section 166 in FIG. 5.

The door control section 166 is composed of a manipulation signal detecting section 181, a judgment section 182, and a running state detecting section 183 each of which is a logic circuit (signal processing circuit), for example, which performs logical operations on a received signal.

The manipulation signal detecting section 181 detects that an open SW 161a, a close SW 161b, an open SW 162a, or a close SW 162b has been manipulated when receiving a manipulation signal of the open SW 161a, close SW 161b, open SW 162a, or close SW 162b which is supplied from an indoor manipulation section 161 or an outdoor manipulation section 162. The manipulation signal detecting section 181 supplies the received manipulation signal to the judgment section 182.

The judgment section 182 is supplied by the manipulation signal detecting section 181 with a manipulation signal of an open SW 161a, a close SW 161b, an open SW 162a, or a close SW 162b. The judgment section 182 judges, on the basis of a status signal supplied from the running state detecting section 183, whether the manipulation on the open SW 161a, close SW 161b, open SW 162a, or close SW 162b that has been detected by the manipulation signal detecting section 181 is a normal one or an abnormal one, and performs a control suitable for the judgment result.

More specifically, if a manipulation on an inside open SW 161a or close SW 161b or an outside open SW 162a or close SW 162b is detected in a state that a status signal indicating the vehicle's being in a stop state is being supplied from the running state detecting section 183, the judgment section 182 judges that the detected manipulation is a normal one and supplies the door actuator 170 with a door open operation instruction signal or a door close operation instruction signal corresponding to the manipulation signal of the open SW 161a, close SW 161b, open SW 162a, or close SW 162b.

On the other hand, if supplied by the manipulation signal detecting section 181 with a manipulation signal of an outside open SW 162a in a state that a status signal indicating the vehicle's being in a running state is being supplied from the running state detecting section 183, the judgment section 182 judges that the detected manipulation is an abnormal one and supplies a control signal indicating occurrence of an abnormal manipulation to the main control section 164 via the bus 165 (see FIG. 5) without supplying a door open operation signal to the door actuator 170.

If supplied by the manipulation signal detecting section 181 with a manipulation signal of the open SW 161a or the close SW 161b of an indoor manipulation section 161 in a state that a status signal indicating the vehicle's being in a running state is being supplied from the running state detecting section 183, the judgment section 182 judges that the detected manipulation is a prohibited one and does not supply a door open operation signal or a door close operation signal to the door actuator 170. This is because this event is merely such that a passenger in the vehicle inadvertently touched or mischievously manipulated the open SW 161a or the close SW 161b of the indoor manipulation section 161 and hence it does not require an emergency measure unlike in a case of a door manipulation from outside the vehicle during a run. The fact that an open SW 161a or a close SW 161b was manipulated may be displayed on the meter panel. In this case, the driver can recognize that the door open or close manipulation has been performed and can warn the passengers not to manipulate an open SW 161a or a close SW 161b during a run.

The judgment section 182 may supply a control signal indicating occurrence of an abnormal manipulation to the main control section 164 via the bus 165 also when supplied by the manipulation signal detecting section 181 with a manipulation signal of an outside close SW 162b in a state that a status signal indicating the vehicle's being in a running state is being supplied from the running state detecting section 183.

The above-described processing of the judgment section 182 is processing of a case that each door as an opening/closing member of the vehicle is of such a type as to be able to be opened or closed electrically (electric slide door) when an event that a person has touched the associated vehicle door handle is detected by a sensor or the like or a manipulation on a switch disposed adjacent to the driver's seat is detected.

Where the doors cannot be opened or closed electrically (i.e., they are opened or closed manually), the judgment section 182 merely judges whether a manipulation detected by the manipulation signal detecting section 181 is an abnormal one or a normal one on the basis of whether the vehicle is in a running state or a stop state and outputs a control signal to the main control section 164. That is, the judgment section 182 does not supply an open operation instruction signal or a close operation instruction signal to the door actuator 170.

The running state detecting section 183 detects a vehicle running state by receiving, from the running control section 167, a status signal indicating the vehicle's being in a running state or a stop state. The running state detecting section 183 supplies the received status signal to the judgment section 182.

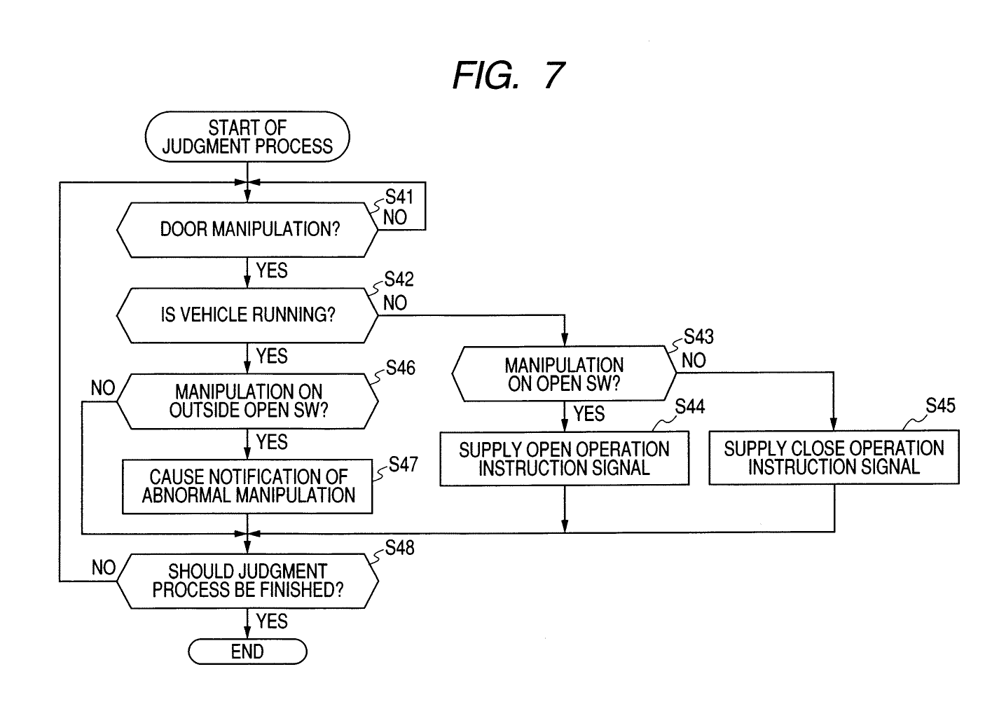

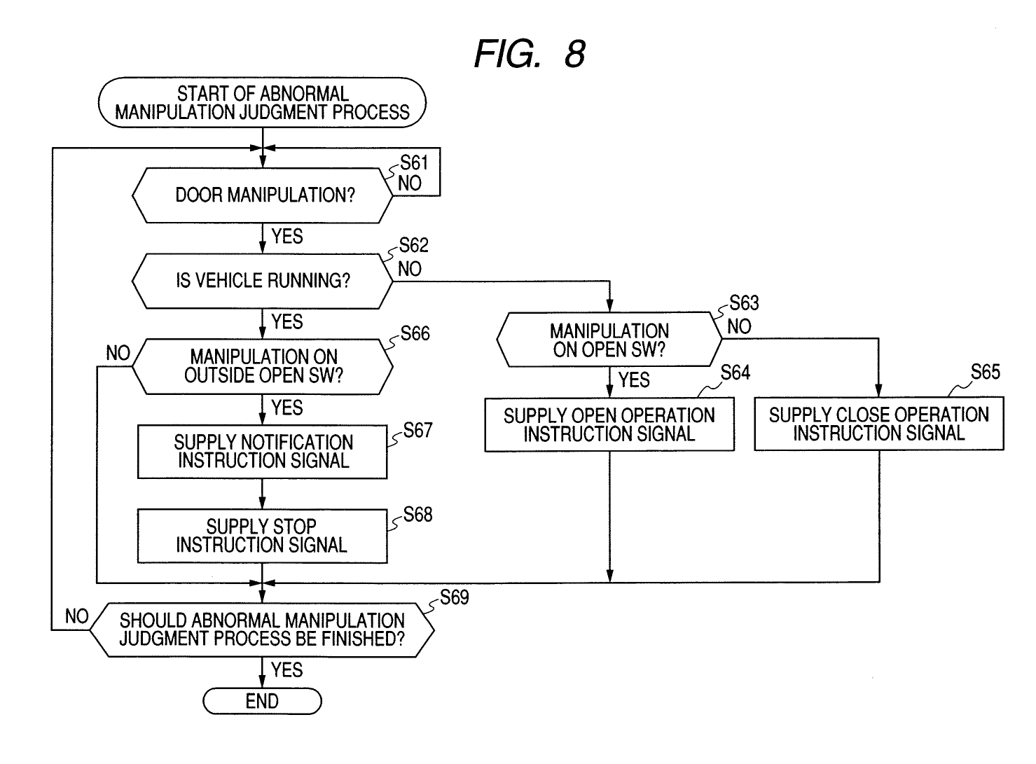

Next, a judgment process of the judgment section 182 of the automobile control system 111 will be described below with reference to a flowchart of FIG. 7. For example, this process and a process of FIG. 8 (described later) are started upon a start of the engine of the vehicle and executed in parallel.

First, at step S41, the judgment section 182 judges whether or not a door manipulation has been performed. This step is executed repeatedly until it is judged that a door manipulation has been performed.

If it is judged at step S41 that a door manipulation has been performed, that is, if a manipulation signal of an inside open SW 161a or close SW 161b or an outside open SW 162a or close SW 162b is supplied from the manipulation signal detecting section 181, the judgment section 182 judges at step S42 whether or not the vehicle is running.

If it is judged at step S42 that the vehicle is not running (i.e., it is stopped), the judgment section 182 judges at step S43 whether the manipulation detected at step S41 is a manipulation on an inside open SW 161a or an outside open SW 162a.

If it is judged at step S43 that the detected manipulation is a manipulation on an inside open SW 161a or an outside open SW 162a, at step S44 the judgment section 182 supplies the door actuator 170 with a door open operation instruction signal corresponding to the manipulation signal of the open SW 161a or 162a. Then, the judgment section 182 moves to step S48.

On the other hand, if it is judged at step S43 that the detected manipulation is a manipulation on an inside close SW 161b or an outside close SW 162b, at step S45 the judgment section 182 supplies the door actuator 170 with a door close operation instruction signal corresponding to the manipulation signal of the close SW 161b or 162b. Then, the judgment section 182 moves to step S48.

On the other hand, if it is judged at step S42 that the vehicle is running, the judgment section 182 judges at step S46 whether the manipulation detected at step S41 is a manipulation on an open SW 162a that is provided on the outside of the vehicle body.

If it is judged at step S46 that the detected manipulation is not a manipulation on an open SW 162a provided on the outside of the vehicle body, that is, if it is a manipulation on an inside open SW 161a or close SW 161b, the process moves to step S48 skipping step S47.

On the other hand, if it is judged at step S46 that the detected manipulation is a manipulation on an open SW 162a provided on the outside of the vehicle body, at step S47 the judgment section 182 judges that the manipulation on the open SW 162a of the outdoor manipulation section 162 which was detected at step S41 is an abnormal manipulation and supplies (outputs) a control signal indicating occurrence of an abnormal manipulation to the main control section 164 via the bus 165. Then, the judgment section 182 moves to step S48.

At step S48, the judgment section 182 judges whether or not the judgment process should be finished. If judging that the judgment process should not be finished, the judgment section 182 returns to step S41, whereby the above-described steps S41-S48 will be executed again.

On the other hand, if judging that the judgment process should be finished, the judgment section 182 finishes the process. For example, the judgment section 182 judges that the process should be finished when the vehicle engine has stopped.

An abnormal manipulation accommodating process which is executed by the main control section 164 when it is supplied by the door control section 166 with a control signal indicating occurrence of an abnormal manipulation is the same as described above with reference to FIG. 4, and hence will not be described.

As described above, if a manipulation on the open SW 162a of an outdoor manipulation section 162 is detected while the vehicle is running, the judgment section 182 of the door control section 166 judges that the manipulation is an abnormal one and communicates a control signal indicating occurrence of an abnormal manipulation to the main control section 164. In this manner, an abnormal manipulation can be detected quickly.

When receiving a control signal indicating occurrence of an abnormal manipulation, the main control section 164 causes the notification section 173 to ring the buzzer, which allows the driver or the passengers to recognize the occurrence of the abnormal manipulation immediately. When receiving a control signal indicating occurrence of an abnormal manipulation, the main control section 164 outputs a stop instruction signal for causing the vehicle to make an emergency stop. In this manner, a measure for securing safety of the person who is making the manipulation outside the vehicle can be taken quickly.

Also in the automobile control system 111, the notification section 173 may incorporate devices other than the buzzer, such as speakers. In this case, when supplied by the main control section 164 with a notification instruction signal, the notification section 168 outputs to the notification section 73 a voice message such as “The door of the rear-left seat has been manipulated during a run!” This allows the driver and the passengers to instantaneously recognize not only the occurrence of the abnormality but also its content and the location of the manipulated door.

Where the notification section 173 incorporates speakers, when the door handle of a manual door is manipulated in a state that the door is not locked, a voice message such as “The door of the rear-left seat is opening” may be output.

A voice message may be output from the speaker that is disposed near a manipulated door. This makes it possible to recognize the door also on the basis of the direction from which a generated voice comes.

The notification section 173 may incorporate both of a buzzer and speakers and cause both of ringing of the buzzer and output of a voice message.

The notification section 173 may incorporate a warning lamp (indicator) on the meter panel and visually notify the driver of an abnormal manipulation. It is also possible to visually notify the driver of an abnormal manipulation by making a display that is different (in the lighting method) from a display showing that a door is opened normally using an indicator on the meter panel which serves to indicate that a door(s) is open.

Whether the vehicle is running or stopped can be judged by detecting a thing other than the rotation state of the wheels, such as a drive manipulation of the driver. For example, a judgment result that the vehicle is running can be produced when the shift knob of the transmission is located at such a position that the vehicle can run, such as the drive position or the reverse position.

A judgment result that the vehicle is running can also be produced when the auxiliary brake has just been or is disengaged or the acceleration pedal has just been or is stepped on in a state that the vehicle is stopped. This judging method makes it possible to detect an abnormal manipulation that is performed immediately before a start of the vehicle. Judgment can also be made by detecting a factor in causing a transition from a stopped state to a running state of the vehicle by using another state such as the engine state or the steering state.

In the above-described automobile control system 111 of FIG. 5, the door control section 166 judges whether a manipulation just detected is an abnormal one or a normal one. If judging that the manipulation is an abnormal one, the door control section 166 supplies the main control section 164 with a control signal indicating occurrence of an abnormal manipulation. The main control section 164 supplies a notification instruction signal to the notification control section 168 and supplies a stop instruction signal to the running control section 167. Alternatively, the door control section 166 may directly supply a stop instruction signal to the running control section 167 or directly supply a notification instruction signal to the notification control section 168.

FIG. 8 is a flowchart of an abnormal manipulation judgment process of the automobile control system 111 of FIG. 5 which is modified in the above manner.

First, at step S61, the judgment section 182 judges whether or not a door manipulation has been performed. This step is executed repeatedly until it is judged that a door manipulation has been performed.

If it is judged at step S61 that a door manipulation has been performed, that is, if a manipulation signal of an inside open SW 161a or close SW 161b or an outside open SW 162a or close SW 162b is supplied from the manipulation signal detecting section 181, the judgment section 182 judges at step S62 whether or not the vehicle is running.

If it is judged at step S62 that the vehicle is not running (i.e., it is stopped), the judgment section 182 judges at step S63 whether the manipulation detected at step S61 is a manipulation on an inside open SW 161a or an outside open SW 162a.

If it is judged at step S63 that the detected manipulation is a manipulation on an inside open SW 161a or an outside open SW 162a, at step S64 the judgment section 182 supplies the door actuator 170 with a door open operation instruction signal corresponding to the manipulation signal of the open SW 161a or 162a. Then, the judgment section 182 moves to step S69.

On the other hand, if it is judged at step S63 that the detected manipulation is a manipulation on an inside close SW 161b or an outside close SW 162b, at step S65 the judgment section 182 supplies the door actuator 170 with a door close operation instruction signal corresponding to the manipulation signal of the close SW 161b or 162b. Then, the judgment section 182 moves to step S69.

On the other hand, if it is judged at step S62 that the vehicle is running, the judgment section 182 judges at step S66 whether the manipulation detected at step S61 is a manipulation on an open SW 162a that is provided on the outside of the vehicle body.

If it is judged at step S66 that the detected manipulation is not a manipulation on an open SW 162a provided on the outside of the vehicle body, that is, if it is a manipulation on an inside open SW 161a or close SW 161b, the process moves to step S69 skipping steps S67 and S68.

On the other hand, if it is judged at step S66 that the detected manipulation is a manipulation on an open SW 162a provided on the outside of the vehicle body, at step S67 the judgment section 182 judges that the manipulation on the open switch 162a of the outdoor manipulation section 162 which was detected at step S61 is an abnormal manipulation and supplies (outputs) a notification instruction signal to the notification control section 168. In response, the notification section 173 rings the buzzer.

After executing step S67, at step S68 the judgment section 182 supplies a stop instruction signal to the running control section 167. In response, the running control section 167 stops the vehicle by controlling the motor 171 and the brake 172.

At step S69, the judgment section 182 judges whether or not the abnormal manipulation judgment process should be finished. If judging that the abnormal manipulation judgment process should not be finished, the judgment section 182 returns to step S61, whereby the above-described steps S61-S69 will be executed again.

On the other hand, if judging that the abnormal manipulation judgment process should be finished, the judgment section 182 finishes the process.

As described above, if a manipulation on the open SW 162a of an outdoor manipulation section 162 is detected while the vehicle is running, the judgment section 182 of the door control section 166 judges that the manipulation is an abnormal one, which makes it possible to cause the notification section 173 to ring the buzzer and cause an emergency stop of the vehicle. In this manner, an abnormal manipulation can be detected quickly and a measure for securing safety of the person who is making the manipulation outside the vehicle can be taken quickly.

In an automobile incorporating the automobile control system 111, danger in the following exemplary situations can be avoided.

[Situation 1]

Although a passenger who is to be seated on the rear seats is located outside the vehicle (i.e., he or she is not in the vehicle), the driver starts the vehicle with a misunderstanding that the passenger has returned to inside the vehicle. Although the passenger located outside manipulates the rear-left electric slide door handle, the door is not opened because it is locked by the automatic door locking mechanism which has detected the start of the vehicle. A dangerous situation occurs that the passenger is manipulating the electric slide door handle while the vehicle is running.

[Situation 2]

The driver is doing some work outside the vehicle that is stopped with its engine in operation. The vehicle starts because of an insufficient degree of pulling of the parking brake. Although the driver tries to open a door to stop the vehicle, the door cannot be opened because it is locked. This is also a dangerous situation.

In each of situation 1 and situation 2, since the manipulation on the open SW 162a for open the door from outside the vehicle is detected while the vehicle is running, it can be detected quickly as an abnormal manipulation. The notification section 173 can ring the buzzer to notify the driver that the passenger is located outside the vehicle and it is possible to cause the vehicle to make an emergency stop by controlling the motor 171 and the brake 172. A dangerous situation can thus be avoided.

The above-described series of steps can be executed either by hardware or software. Where the series of steps is executed by software, programs constituting the software are installed from a program recording medium to a computer that is incorporated in dedicated hardware or a computer which can perform various functions when various programs are installed therein.

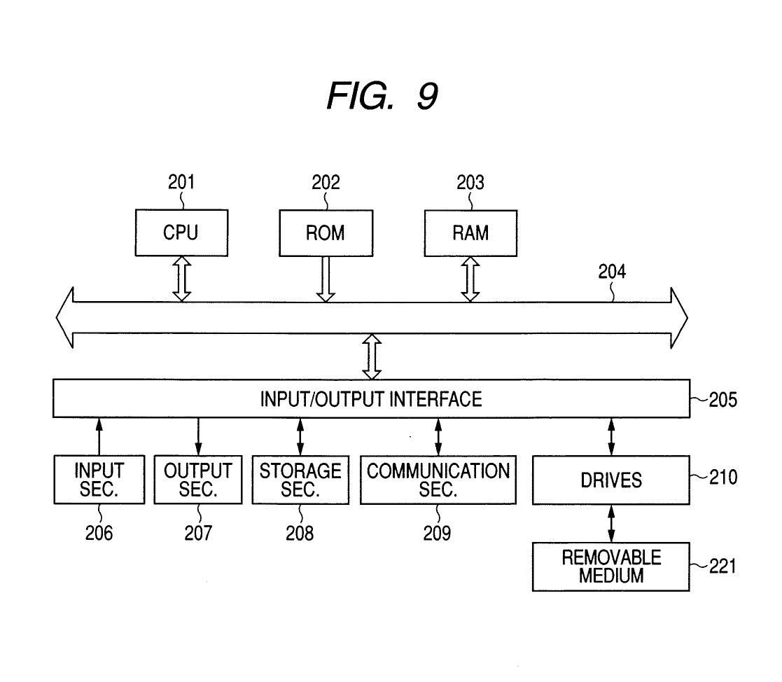

FIG. 9 is a block diagram showing an exemplary configuration of a computer which executes the above-described series of steps. A CPU (central processing unit) 201 performs various kinds of processing according to programs stored in a ROM (read-only memory) 202 or a storage section 208. Programs to be executed by the CPU 201, data, etc. are stored in a RAM (random access memory) 203 when necessary. The CPU 201, the ROM 202, and the RAM 203 are connected to each other via a bus 204.

An input/output interface 205 is also connected to the CPU 201 via the bus 204. An input section 206 consisting of a keyboard, a mouse, a microphone, etc. and an output section consisting of a display such as a CRT (cathode-ray tube) display or an LCD (liquid crystal display), a speaker, etc. are connected to the output section 207. The CPU 201 performs various kinds of processing according to instructions supplied from the input section 206. And the CPU 201 outputs a processing result to the output section 207.

The storage section 208, which is connected to the input/output interface 205 and is a hard disk drive, for example, stores programs to be executed by the CPU 201 and various data. A communication section 209 communicates with external apparatus which are connected directly or via a network such as the Internet or a local area network.

The communication section 209 may be such as to perform either wireless communication or wired communication or even such as to perform both of wireless communication and wired communication. No restrictions are imposed on its communication method. For example, in the case of wireless communication, various wireless communication methods can be used which include Bluetooth and wireless LAN (local area network) such as IEEE (The Institute of Electrical and Electronics Engineers, Inc.) 802.11a, 802.11b, and 802.11g. In the case of wired communication, various wired communication methods can be used which include IEEE 1394, Ethernet (registered trademark), and USB (universal serial bus).

When mounted with a removable medium 221 such as a magnetic disk, an optical disc, or a semiconductor memory, the drives 210 which are connected to the input/output interface 205 drive it and acquire programs, data, etc. recorded therein. The acquired programs, data etc. are transferred to and stored in the storage section 208 when necessary. Programs, data, etc. may be acquired via the communication section 209 and stored in the storage section 208.

As shown in FIG. 9, the removable medium 221 which is a package medium such as a magnetic disk (including a flexible disk), an optical disc (including a CD-ROM (compact disc-read only memory), and a DVD (digital versatile disc)), a magneto-optical disc), or a semiconductor memory, the ROM 202 in which programs are stored temporarily or permanently, the storage section 208 (hard disk drive), etc. constitute program recording media for storing programs that are installed in the computer and rendered executable by the computer. When necessary, programs are stored in the program recording media via the communication section 209 which is an interface such as a router or a modem using a wired or wireless communication medium such as a local area network, the Internet, or digital satellite broadcast.

In this specification, the steps described in each flowchart may naturally be executed in the time-series order as written. However, they need not always be executed in the time-series order; part of them may be executed in parallel or individually.

In this specification, the term “system” means the entire apparatus consisting of plural apparatus and devices.

The invention is not limited to the above embodiments and various modifications are possible without departing from the spirit and scope of the invention.

What is claimed is:

1. A control apparatus of a mobile body which runs while carrying persons, comprising:
detecting means for detecting a manipulation that is performed on a manipulation member to open or close an opening/closing member from outside the mobile body; and
output means for outputting a control signal indicating occurrence of an abnormal manipulation if a manipulation that is performed on a manipulation member to open an opening/closing member from outside the mobile body is detected in a state that an open operation of the opening/closing member is prohibited.

2. The control apparatus according to claim 1, wherein the state that an open operation of the opening/closing member is prohibited is a state that the mobile body is running.

3. The control apparatus according to claim 2, wherein the output means outputs, as the control signal, a control signal for causing an operation of notifying a driver of the mobile body or a control signal for causing an operation of stopping the mobile body which is running.

4. The control apparatus according to claim 1, wherein the control apparatus is a control apparatus for the opening/closing member.

5. A control method of a mobile body which runs while carrying persons, comprising the steps of:
detecting a manipulation that is performed on a manipulation member to open or close an opening/closing member from outside the mobile body; and
outputting a control signal indicating occurrence of an abnormal manipulation if a manipulation that is performed on a manipulation member to open an opening/closing member from outside the mobile body is detected in a state that an open operation of the opening/closing member is prohibited.

6. A program for causing a computer to execute a control process for controlling a mobile body which runs while carrying persons, the control process comprising the steps of:
detecting a manipulation that is performed on a manipulation member to open or close an opening/closing member from outside the mobile body; and
outputting a control signal indicating occurrence of an abnormal manipulation if a manipulation that is performed on a manipulation member to open an opening/closing member from outside the mobile body is detected in a state that an open operation of the opening/closing member is prohibited.
